(19) United States
(12) Patent Application Publication
(10) Pub. No.: US 2012/0041825 A1
(43) Pub. Date: Feb. 16, 2012

(54) CONTEXTUAL TRANSLATION OF NON-INTERACTIVE ADVERTISEMENTS INTO INTERACTIVE ADVERTISEMENTS

(76) Inventors: Kabir S. KASARGOD, San Diego, CA (US); Brian MINEAR, San Diego, CA (US)

(21) Appl. No.: 12/856,764

(22) Filed: Aug. 16, 2010

(51) Int. Cl. G06Q 30/00

(52) U.S. Cl. 705/14.68

(57) ABSTRACT

Apparatus and methods trigger delivery of interactive advertisements to devices, such as wireless mobile devices, based upon exposure of a user to non-interactive advertisements. The non-interactive advertisements may include advertisements such as publicly displayed billboards or video advertisements embedded into broadcast programming There are many places and many instances where a device user may be exposed to an advertisement, and often the user does not have the ability to retain information associated with the advertisement. Rather than merely utilizing contextual information limited to user location or user profile information, the apparatus and methods correlate one or more behavioral context parameters to exposure, including exposure duration, in order to ascertain a user's interest in the non-interactive advertisement and thus suitability for receiving a corresponding interactive advertisement.

### BACKGROUND

The present disclosure relates to an interactive operating environment, and more particularly, to providing improved apparatus and methods of generating interactive advertisements to users of a device based upon exposure and context of experiencing non-interactive advertisements.

For many years, companies have tried to brand their products, satisfy existing consumers, and reach potential new consumers through traditional means. The evolution includes advertising ranging from print forms like newspapers, magazines, brochures, newsletters, press releases, and billboards, to event-related activities, like sponsorships, seminars, point-of-sale and promotional programs, to broadcast media, like radio, television, cable, and recently satellite cable.

In recent years, there has been a rise of advertising that is more targeted and tailored to individual consumers, with new forms of previously so-called direct advertising. New endeavors have sought to interact directly with consumers through pull campaigns and push campaigns, and make advertising more measurable to bring advertisers specific consumer data mining information bearing on consumer buying habits, trends and predicted future habits. Advances in technology outlets combined with marketing ingenuity have expanded the old direct mail marketing campaigns into new branches, including telemarketing, point-of-sale campaigns, computer platforms, and most recently distribution and measurement through telecommunications networks.

With respect to the latter, perhaps the greatest platform for the new world of marketing has been the same as the greatest platform for information exchange in the last decade, namely the Internet. Through such avenues as branded websites, banner ads, pop-up ads, targeted e-mails, portal sponsorships, to name a few examples, advertisers have been able to hone in on target audiences. Through defined metrics and innovative semantics, like served impressions, click-through rate (CTR), cost per action (CPA), cost per click (CPC), cost per sale (CPS), and cost per thousand (CPM), to name a few, advertisers have been able to measure the results of targeted ads and objectively set fees based on performance results. Along with these new advances, and because of the increasingly cosmopolitan nature of business, geopolitics, and integrated telecommunications networks, so too has advertising become increasingly global in nature.

Traditional static advertising venues such as billboards have received some improvements by incorporating active, electronic elements for dynamically changing advertisements. Thereby, the media content is more interesting and can be varied in order to better tailor the advertisements for a targeted audience. For example, those commuting downtown for work can constitute a different audience demographic as compared to midday drivers. While such added dynamism has increased the advertising value of traditional advertising venues, these dynamic advertising venues still lack the degree of targeting and marketing feedback that are enjoyed by more interactive advertising channels.

In particular, as non-interactive media, it is difficult to ascertain interest by potential customers who may have passively viewed or listened to advertisements (e.g., television, billboards, etc.).

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In one aspect, a method of delivering advertisements is provided. The method includes determining exposure to a non-interactive advertisement. The method further includes determining at least one behavioral context parameter corresponding to the exposure to the non-interactive advertisement. The at least one behavioral context parameter includes an exposure duration of the exposure to the non-interactive advertisement. The method further includes determining whether a correlation exists between the non-interactive advertisement and the at least one behavioral context parameter. The correlation includes, at least in part, determining that the exposure duration achieves an exposure threshold. Additionally, the method includes generating a trigger to obtain an interactive advertisement corresponding to the non-interactive advertisement if the correlation exists.

In another aspect, at least one processor is provided for delivering advertisements. A first module determines exposure to a non-interactive advertisement. A second module determines at least one behavioral context parameter corresponding to the exposure to the non-interactive advertisement. The at least one behavioral context parameter includes an exposure duration of the exposure to the non-interactive advertisement. A third module determines whether a correlation exists between the non-interactive advertisement and the at least one behavioral context parameter. The correlation includes, at least in part, determining that the exposure duration achieves an exposure threshold. A fourth module generates a trigger to obtain an interactive advertisement corresponding to the non-interactive advertisement if the correlation exists.

In an additional aspect, a computer program product including a computer-readable storage medium is provided for delivering advertisements. The computer-readable storage medium includes at least one instruction for causing a computer to determine exposure to a non-interactive advertisement. The computer-readable storage medium further includes at least one instruction for causing the computer to determine at least one behavioral context parameter corresponding to the exposure to the non-interactive advertisement. The at least one behavioral context parameter includes an exposure duration of the exposure to the non-interactive advertisement. The computer-readable storage medium further includes at least one instruction for causing the computer to determine whether a correlation exists between the non-interactive advertisement and the at least one behavioral context parameter. The correlation includes, at least in part, determining that the exposure duration achieves an exposure threshold. The computer-readable storage medium further includes at least one instruction for causing the computer to generate a trigger to obtain an interactive advertisement corresponding to the non-interactive advertisement if the correlation exists.

In a further aspect, an apparatus is provided for delivering advertisements. The apparatus includes means for determining exposure to a non-interactive advertisement. The apparatus further includes means for determining at least one behavioral context parameter corresponding to the exposure to the non-interactive advertisement. The at least one behavioral context parameter includes an exposure duration of the exposure to the non-interactive advertisement. Further, the apparatus includes means for determining whether a correlation exists between the non-interactive advertisement and the at least one behavioral context parameter. The correlation includes, at least in part, determining that the exposure duration achieves an exposure threshold. Additionally, the apparatus includes means for generating a trigger to obtain an interactive advertisement corresponding to the non-interactive advertisement if the correlation exists.

In yet another aspect, an apparatus is provided for delivering advertisements. The apparatus includes an exposure determiner, a behavioral context determiner, a correlator, and a network interface. The exposure determiner determines exposure to a non-interactive advertisement. The behavioral context determiner determines at least one behavioral context parameter corresponding to the exposure to the non-interactive advertisement. The at least one behavioral context parameter includes an exposure duration of the exposure to the non-interactive advertisement. The correlator determines whether a correlation exists between the non-interactive advertisement and the at least one behavioral context parameter. The correlation includes, at least in part, determining that the exposure duration achieves an exposure threshold. The correlator further generates a trigger. The network interface obtains an interactive advertisement corresponding to the non-interactive advertisement if the correlation exists based upon the trigger.

To the accomplishment of the foregoing and related ends, the one or more aspects comprise the features hereinafter described in detail and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects.

FIG. 1 illustrates a schematic diagram of an apparatus for delivery of advertisements, according to one aspect.

FIG. 2 illustrates a flow diagram for a methodology or sequence of operations for delivery of interactive advertisements, according to one aspect.

FIG. 3 illustrates a schematic diagram of a distributed system of a server and a client that performs delivery of interactive advertisements, according to one aspect.

FIG. 4 illustrates a flow diagram of an exemplary methodology for targeted delivery of interactive advertisements, according to one aspect.

FIG. 5 illustrates a schematic diagram of one or more aspects of determining sufficient exposure and applicable heuristic triggers associated with an audio or video type of non-interactive advertisement, according to one aspect of the methodology of FIG. 4.

FIG. 6 illustrates a schematic diagram of one or more aspects of determining sufficient exposure and applicable heuristic triggers associated with a static type of non-interactive advertisement, according to one aspect of the methodology of FIG. 4.

FIG. 7 illustrates a schematic diagram of one or more aspects of determining user context relative to others to validate or discount exposure and heuristic triggers, according to one aspect of the methodology of FIG. 4.

FIG. 8 illustrates a schematic diagram of one or more aspects of determining user based on device usage to validate or discount exposure and heuristic triggers, according to one aspect of the methodology of FIG. 4.

FIG. 9 illustrates a schematic diagram of one or more aspects of determining user context based on history or a time window to validate or discount exposure and heuristic triggers, according to one aspect of the methodology of FIG. 4.

FIG. 10 illustrates a schematic diagram of one or more aspects of sending an interactive advertisement corresponding to a non-interactive advertisement to a user, according to one aspect of the methodology of FIG. 4.

FIG. 11 illustrates a schematic diagram for a system such as a mobile device having logical grouping of electrical components for delivery of advertisements, according to one aspect.

FIG. 12 illustrates a schematic diagram of an exemplary computing environment, such as for a network server, remote to a mobile device, according to one aspect.

FIG. 13 illustrates a schematic diagram of an exemplary computing environment, such as a mobile device, for communicating with a remote network server, according to one aspect.

FIG. 14 illustrates a schematic diagram of a distributed architecture for detecting exposure to a non-interactive advertisement and for receiving a corresponding interactive advertisement when appropriate exposure and behavioral context are determined, according to one aspect.

### DETAILED DESCRIPTION

When a user walks in a busy shopping mall or in the middle of Times Square in New York, the user is exposed to physical advertisements for products or services. The described apparatus and methods enable translation of those physical advertisements into interactive advertisements to entice the user to learn more about, or purchase, the advertised product or service. In one aspect, the interactive advertisement may entice the user to enter a nearby physical store or to try the advertised product or service. In another aspect, when a user watches a particular channel on TV, there is an opportunity to translate a non-interactive TV advertisement being watched by the user into an interactive advertisement. In this disclosure, behavioral context information is used to determine a user's interest in a non-interactive advertisement, and to trigger obtaining a translation of the non-interactive advertisement into an interactive advertisement.

As used herein, an advertisement is broadly defined as encompassing a communication, promotion, campaign, etc., with an intent to illicit consumer interest in a particular good or service or to enhance brand identification. Although visual advertisements are depicted in an exemplary manner, it should be appreciated that advertisements can utilize one or more sensory modes (e.g., tactile including Braille lettering, scent, graphical imagery, text, audio including spoken words and music, etc.).

As used herein, a non-interactive advertisement is any advertisement that does not allow for user feedback. For example, a non-interactive advertisement includes, but is not limited to, an audio advertisement that can be heard or a physical advertisement that can be seen, such as in a store, walking down a street, in a mall, etc. Using behavioral context information, including but not limited to a user's actions relative to the non-interactive advertisement, a user's actions relative to others, a difference between a user's and others' actions relative to the non-interactive advertisement, advertisement location, user's location, TV channel and the user's wireless network, and one or more context-related thresholds, the apparatus and methods described herein trigger obtaining a monetizable, interactive, wireless, on-the-go advertisement corresponding to the non-interactive advertisement.

In one aspect, the described apparatus and methods utilize the behavioral context information to define one or more dimensions of user context, which can be utilized to determine an interest level in a non-interactive advertisement. For example, in one dimension, the behavioral context information quantifies a user context relative to others. In other words, this dimension determines what the user is doing as compared to what others are doing. Further, for example, in another dimension, the behavioral context information quantifies a user context relative to the user himself In other words, this dimension determines how a certain current context parameter relates to other current context parameters that define a current user context. Moreover, for example, in yet another dimension, the behavioral context information quantifies a user context relative to a user history. In other words, this dimension determines how a current user context, or a current user context parameter, compares to prior user contexts or context parameters, in order to determine whether a pattern exists, or to otherwise explain the user behavior. Thus, each dimension may be used, individually or in combination with one or more of the other dimensions, in order to determine if the behavioral context information indicates that a user is interested in the non-interactive advertisement, thereby triggering acquisition of a corresponding interactive advertisement.

Various aspects of the disclosure are further described below. It should be apparent that the teaching herein can be embodied in a wide variety of forms and that any specific structure or function disclosed herein is merely representative. Based on the teachings herein one skilled in the art should appreciate that an aspect disclosed herein can be implemented independently of other aspects and that two or more of these aspects can be combined in various ways. For example, an apparatus can be implemented or a method practiced using any number of the aspects set forth herein. In addition, an apparatus can be implemented or a method practiced using other structure or functionality in addition to or other than one or more of the aspects set forth herein. As an example, many of the methods, devices, systems, and apparatus described herein are described in the context of providing dynamic queries and recommendations in a mobile communication environment. One skilled in the art should appreciate that similar techniques could apply to other communication and non-communication environments as well.

As used in this disclosure, the term “content” and “objects” are used to describe any type of application, multimedia file, image file, executable, program, web page, script, document, presentation, message, data, meta-data, or any other type of media or information that may be rendered, processed, or executed on a device.

As used in this disclosure, the terms “component,” “system,” “module,” and the like are intended to refer to a computer-related entity, either hardware, software, software in execution, firmware, middle ware, microcode, or any combination thereof. For example, a component can be, but is not limited to being, a process running on a processor, a processor, an object, an executable, a thread of execution, a program, or a computer. One or more components can reside within a process or thread of execution and a component can be localized on one computer or distributed between two or more computers. Further, these components can execute from various computer readable media having various data structures stored thereon. The components can communicate by way of local or remote processes such as in accordance with a signal having one or more data packets (e.g., data from one component interacting with another component in a local system, distributed system, or across a network such as the Internet with other systems by way of the signal). Additionally, components of systems described herein can be rearranged or complemented by additional components in order to facilitate achieving the various aspects, goals, advantages, etc., described with regard thereto, and are not limited to the precise configurations set forth in a given figure, as will be appreciated by one skilled in the art.

Additionally, the various illustrative logics, logical blocks, modules, and circuits described in connection with the aspects disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any suitable combination thereof designed to perform the functions described herein. A general-purpose processor can be a microprocessor, but, in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other suitable configuration. Additionally, at least one processor can comprise one or more modules operable to perform one or more of the operations or actions described herein.

Moreover, various aspects or features described herein can be implemented as a method, apparatus, or article of manufacture using standard programming or engineering techniques. Further, the operations or actions of a method or algorithm described in connection with the aspects disclosed herein can be embodied directly in hardware, in a software module executed by a processor, or in a combination of the two. Additionally, in some aspects, the operations or actions of a method or algorithm can reside as at least one or any combination or set of codes or instructions on a machine-readable medium or computer readable medium, which can be incorporated into a computer program product. Further, the term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., card, stick, key drive, etc.). Additionally, various storage media described herein can represent one or more devices or other machine-readable media for storing information. The term “computer-readable medium” can include, without being limited to, wireless channels and various other media capable of storing, containing, or carrying instruction, or data. Non-transitory computer-readable medium can include tangible medium that retain computer data structures, instructions and code for an extended period of time.

Furthermore, various aspects are described herein in connection with a mobile device. A mobile device can also be called a system, a subscriber unit, a subscriber station, mobile station, mobile, mobile device, cellular device, multi-mode device, remote station, remote terminal, access terminal, user terminal, user agent, a user device, or user equipment, or the like. A subscriber station can be a cellular telephone, a cordless telephone, a Session Initiation Protocol (SIP) phone, a wireless local loop (WLL) station, a personal digital assistant (PDA), a handheld device having wireless connection capability, or other processing device connected to a wireless modem or similar mechanism facilitating wireless communication with a processing device.

In addition to the foregoing, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. Furthermore, as used in this application and the appended claims, the term “or” is intended to mean an inclusive “or” rather than an exclusive “or.” That is, unless specified otherwise, or clear from context, “X employs A or B” is intended to mean any of the natural inclusive permutations. That is, in this example, X could employ A, or X could employ B, or X could employ both A and B, and thus the statement “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms to “infer” or “inference” refer generally to the process of reasoning about or deducing states of a system, environment, or user from a set of observations as captured via events or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events or data. Such inference results in the construction of new events or actions from a set of observed events or stored event data, whether the events are correlated in close temporal proximity, and whether the events and data come from one or several event and data sources.

Various aspects are now described with reference to the drawings. In the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form in order to facilitate describing these aspects.

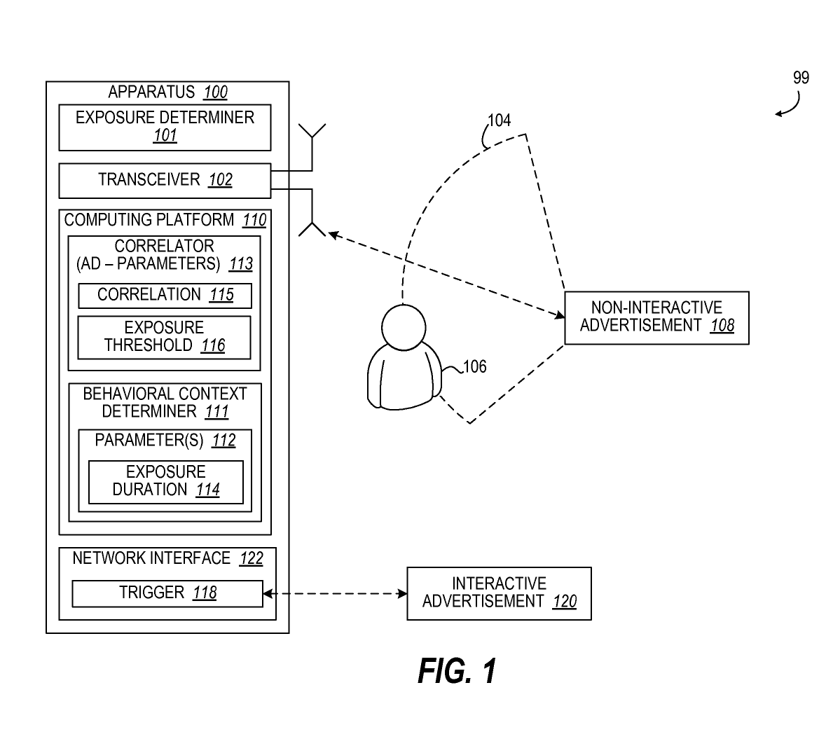

With initial reference to FIG. 1, a system 99 for enabling obtaining of interactive advertisements includes an apparatus 100 having an exposure determiner 101 that determines exposure 104 of a user 106 to a non-interactive advertisement 108. For example, a transceiver 102 can assist in determining this exposure 104 based upon remotely sensed information relayed to the apparatus 100. Alternatively, or in addition, the exposure 104 can in part be determined by directly detecting the presence of the non-interactive advertisement 108 (e.g., detecting an electromagnetic signal emanating from the non-interactive advertisement 108). As another alternative, or another addition, the exposure 104 can be based in part upon receiving a signal conveying location information (e.g., position/location system signal, direction finding based on fixed broadcast sources, etc.). The apparatus 100 may further include a computing platform 110 having a behavioral context determiner 111 that determines one or more behavioral context parameters 112 corresponding to the exposure 104 to the non-interactive advertisement 108, wherein the one or more behavioral context parameters 112 include an exposure duration 114 of the exposure 104 to the non-interactive advertisement 108. The computing platform 110 further has a correlator 113 that determines whether a correlation 115 exists between the non-interactive advertisement 108 and the one or more behavioral context parameters 112, wherein the correlation 115 includes, at least in part, determining that the exposure duration 114 achieves an exposure threshold 116. The correlator 113 generates a trigger 118 that obtains an interactive advertisement 120 corresponding to the non-interactive advertisement 108 if the correlation 115 exists, such as via network interface 122.

In one aspect, the apparatus 100 comprises a handset that is entirely or largely able to autonomously obtain interactive advertisements 120 as well as the requisite one or more behavioral context parameters 112 and to determine exposure duration 114. In another aspect, interactive advertisements 120 are pushed to the apparatus 100 with entirely or a substantial portion of the processing performed remotely. In another aspect, the apparatus 100 is a distributed computing platform wherein a certain functions are performed remotely or collaboratively performed both locally and remotely.

For clarity, exemplary aspects are described herein with regard to mobile devices. However, it should be appreciated that with the benefit of the present disclosure, certain implementations can utilize fixed, distributed, or portable systems or devices. For instance, a facility or pedestrian area can have one or more interactive kiosks, workstations, or devices that can perform portions of the disclosed aspects. For instance, one device can sense exposure duration while another device serves to present an interactive advertisement to a user.

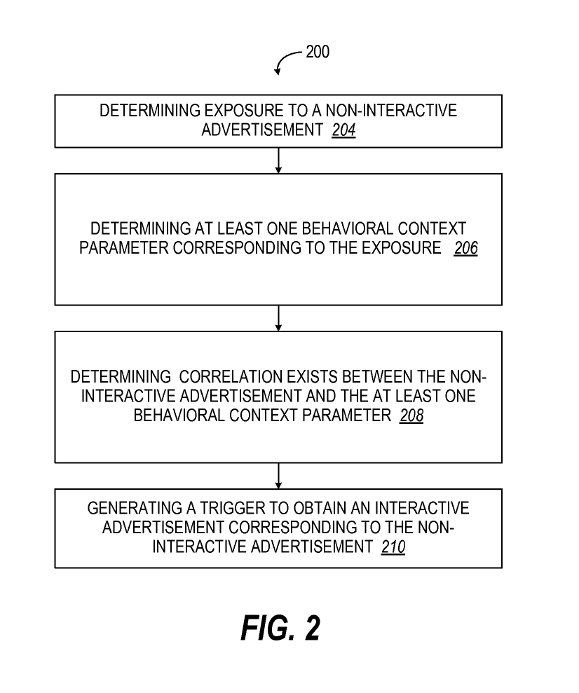

In FIG. 2, a methodology or sequence of operations 200 is provided for obtaining interactive advertisements, according to one aspect. Determining exposure to a non-interactive advertisement is performed at 204. At 206, one or more behavioral context parameters corresponding to the exposure to the non-interactive advertisement are determined The one or more behavioral context parameters include, for example, an exposure duration of the exposure to the non-interactive advertisement.

The methodology or sequence of operations 200 further includes determining whether a correlation exists between the non-interactive advertisement and the one or more behavioral context parameters at 208. The correlation includes, at least in part, determining that the exposure duration achieves an exposure threshold. In an aspect, for example, determining that the exposure duration achieves the exposure threshold may comprise determining that the exposure duration is greater than a sample population exposure time that is a function of a plurality of user exposure times corresponding to the non-interactive advertisement collected from a plurality of users. Further, for example, the sample population exposure time may include an average exposure time spent by the plurality of users in a vicinity of the non-interactive advertisement within a time period. The plurality of users may include either all the users in the vicinity of the non-interactive advertisement within the time period, or a subset of all the users in the vicinity of the non-interactive advertisement within the time period. In other aspects, determining that the exposure duration achieves the exposure threshold may include one or more of: determining that the exposure duration is greater than an average time the user spent at other locations within a time period; determining that the exposure duration is greater than a minimum exposure time; determining, in combination with the exposure duration and based on history information of user movements over a time period, that a pattern of historical exposure durations corresponds to the non-interactive advertisement; determining that the exposure duration does not occur during a time period corresponding to a user interaction with a wireless device; determining that the exposure duration is greater than a minimum portion of an advertisement duration, and determining that other advertisement exposure information for other advertisements adjacent in time to the non-interactive advertisement indicates a lack of other advertisement exposure; or determining that the exposure duration combined with a user behavior advertisement history indicates interest in the non-interactive advertisement. The user behavior advertisement history can include at least one of information indicating that the non-interactive advertisement is viewed more than once for greater than a minimum viewing time over a time period, information indicating that the non-interactive advertisement is viewed more than once across multiple channels over a time period, information indicating that the non-interactive advertisement is paused, rewound or replayed, or information indicating that a user rating greater than a minimum rating threshold is received during the exposure duration.

Also, the methodology or sequence of operations 200 further includes generating a trigger to obtain an interactive advertisement corresponding to the non-interactive advertisement, if the correlation exists at 210. In an aspect, the interactive advertisement is obtained at a location determined based on one or more behavioral context parameters of the user. In other aspect, the interactive advertisement may be obtained by: receiving on a wireless device when location information of the wireless device corresponds to a vicinity of the non-interactive advertisement during the exposure duration; receiving at an e-mail account or on a wired communication device when the one or more behavioral context parameters identify a subject matter of the interactive advertisement as corresponding to historical purchases over the Internet using the wired communication device; receiving at an e-mail account or on a wired communication device when the one or more behavioral context parameters identify a user velocity greater than a velocity threshold; receiving via a text message; or receiving via an Internet Protocol television pop-up menu.

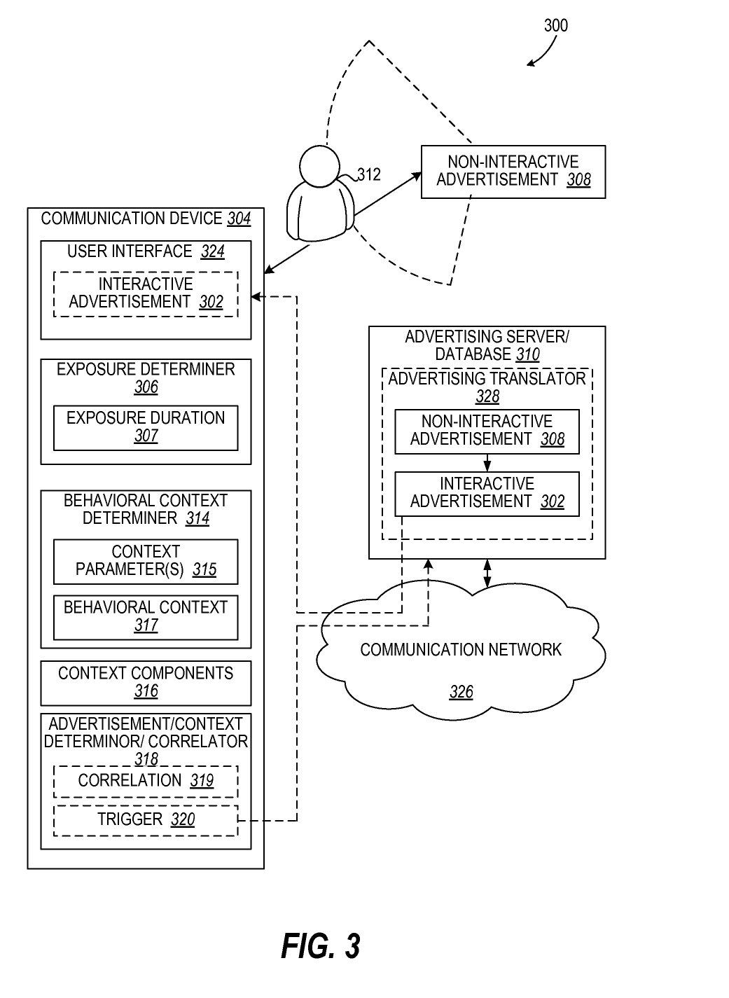

With reference to FIG. 3, the described aspects may be implemented in a system 300 for obtaining interactive advertisements 302, according to one aspect. More particularly, the system 300 includes a communication device 304, such as a mobile phone, Personal Digital Assistant (PDA), or a television that includes an exposure determiner 306 that is able to determine exposure to a non-interactive advertisement 308. It should be noted that communication device 304 and non-interactive advertisement 308 may be the same as, or similar to, the respective apparatus 100 and non-interactive advertisement 108 of FIG. 1, respectively. A non-interactive advertisement 308 may include, for example, a billboard, a sign, a television commercial, or any other advertisement that does not allow user interaction. Further, for example, the communication device 304 may include an exposure determiner 306 to identify that a user 312 is in a vicinity or proximity of a non-interactive advertisement 308, whose location may be known, such as from an advertisement server/database 310 or from a channel to which a user 312 is tuned. The exposure determiner 306 may be the same as or similar to exposure determiner 101 (FIG. 1). For instance, the exposure determiner 306 may get location information from a satellite-based or terrestrial network-based position-location system, and correlate the location with the known locations of advertisements within a certain range of the location in order to determine exposure duration 307. For example, the range may vary depending on a visibility of the ad, e.g., a sign in a store window might have a first range smaller than a second range for a billboard. Also, the exposure determiner 306 can determine an amount of time, or exposure duration, that the user 312 is exposed to the non-interactive advertisement 308. For example, the exposure determiner 306 can ascertain a duration of time spent stationery or travelling within range to see or hear a prominent non-interactive advertisement 308.

Additionally, the system 300 includes a behavioral context determiner 314 that is able to identify one or more contextual information associated with the user, referred to as one or more behavioral context parameters 313. For example, the one or more contextual information or behavioral context parameters 313 may include user movements over time, user interactions with the communication device 304 such as whether the user 312 is making a call or using a program on the communication device 304, etc. Further, for example, the one or more behavioral context parameters 313 may further include population contextual information, such as information on what other users are doing relative to the non-interactive advertisement 308, such as time spent in the vicinity of the non-interactive advertisement 308 or time spent viewing the non-interactive advertisement 308. For example, the advertisement server/database 310 can receive location information from a population of handset subscribers that can be correlated with a database of advertisement customers (not shown). Alternatively or in addition, individual handsets may recognize proximity to a non-interactive advertisement 308 and make appropriate reporting to the advertisement server/database 310. Moreover, the population contextual information may relate to all other users exposed to the non-interactive advertisement 308, or a select group or subset of all other users, such as designated friends of the user. The behavioral context determiner 314 may be the same as or similar to behavioral context determiner 111 (FIG. 1).

Further, the system 300 includes context components 316 that provide one or more behavioral context parameters 313 to the behavioral context determiner 314. For example, the context components 316 may include, but are not limited to, other applications on the communication device 304, such as a voice call application, a web browser, a Global Positioning System (GPS) or position/location application, a text messaging application, a media player application, etc. In addition, the context components 316 may include, but are not limited to, a database storing information related to what is happening in a vicinity of the communication device 304 at any given time. For example, such information may include, but is not limited to, automobile traffic information, local traffic control information such as presence of stop signs or stop lights and the state of a stop light, train information, venue information, or any other information that can help explain what is happening in a vicinity of the communication device 304. As such, the behavioral context determiner 314 collects one or more behavioral context parameters 313 from the context components 316, and based on the one or more behavioral context parameters 313, or based on applying rules or algorithms to the one or more behavioral context parameters 313, is able to determine a behavioral context 317 that describes what is happening on or in a vicinity of the communication device 304 at any given time.

Moreover, the system 300 includes an advertisement/context determiner or correlator 318 that determines whether a correlation 319 exists between the non-interactive advertisement 308 and the one or more behavioral context parameters 313. The advertisement/context determiner or correlator 318 may be the same as or similar to correlator 101 (FIG. 1). For example, the advertisement/context determiner or correlator 318 may include one or any combination of rules, heuristics, fuzzy logic, etc. for determining the correlation 319. The correlation 319 represents that the user 312 is likely interested in the subject matter of the non-interactive advertisement 308. In other words, the advertisement/context determiner or correlator 318 evaluates the exposure to a non-interactive advertisement 308, with reference to one or more behavioral context parameters 313, in order to determine whether user activities correspond to interest in the non-interactive advertisement 308, or whether the user activities can be attributed to some other factor. For example, rather than interest in the non-interactive advertisement 308, the one or more behavioral context parameters 313 may indicate that the user was waiting at a red light, or was stopped to make a voice call, rather than stopping in response to an interest in the product or service promoted by the non-interactive advertisement 308. Accordingly, when the correlation 319 is determined to exist, the advertisement/context determiner or correlator 318 generates a trigger 320 to initiate obtaining of an interactive advertisement 302 corresponding to the non-interactive advertisement 308, such as from a remotely-located source, including but not limited to the advertisement server/database 310. For example, in an aspect, the interactive advertisement 302 allows a user 312 to interact with the interactive advertisement 302 on a user interface 324, such as by clicking on links embedded with the interactive advertisement 302, automatically dialing a phone number, etc.

In an aspect, the trigger 320, which identifies the non-interactive advertisement 308 and the interested user 312 or user communication device 304, is transferred across a communication network 326 and received by, for example, the advertisement server/database 310. In some aspects, the advertisement server/database 310 includes an advertisement translator 328 that generates the interactive advertisement 302 corresponding to the non-interactive advertisement 308 in response to receiving the trigger 320. In other aspects, the advertisement server/database 310 stores the interactive advertisement 302 with an identified relationship to the non-interactive advertisement 308, and thus merely retrieves the interactive advertisement 302 from storage in response to receiving the trigger 320, which may identify the non-interactive advertisement 308 or which includes parameters, such as location information, that allows identification of the non-interactive advertisement 308. In any case, the advertisement server/database 310 transfers the interactive advertisement 302 across the communication network 326 for receipt by the communication device 304, or for receipt by another device, such as a non-mobile or wired device, associated with the user 312. For example, the destination of the interactive advertisement 302 may be determined based on where the user 312 is likely to act on the interactive advertisement 302.

Thus, the system 300 provides apparatus and methods of delivering interactive advertisements 302 based on exposure to non-interactive advertisements 308 and taking into account one or more behavioral context parameters 313 that indicate a likelihood of user interest in the non-interactive advertisement 308.

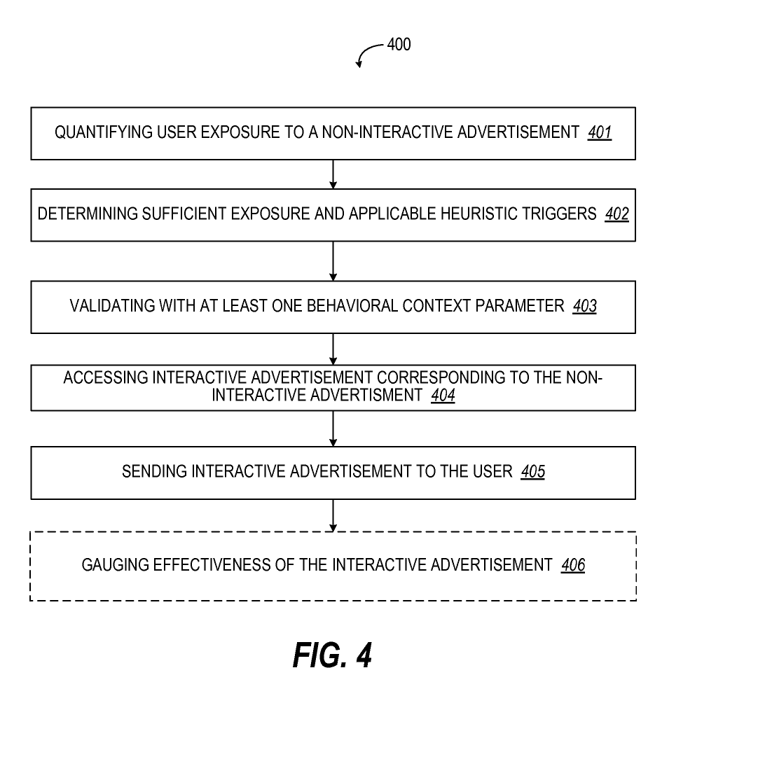

In one aspect, referring to FIG. 4, a methodology 400 is provided for targeted delivery of interactive advertisements based upon determining a user's apparent interest in a non-interactive advertisement, according to one aspect. An exposure by a user to a non-interactive advertisement is quantified at 401. For example, the user is exposed to the non-interactive advertisement, such as but not limited to, receiving a mobile text message, proximity to a static or dynamic billboard, viewing an Internet Protocol Television (IPTV) pop-up, email, hearing an audio advertisement, or some other method. In one aspect, being in a certain retail facility is itself a non-interactive advertisement for certain goods and services. Since the media used for the non-interactive advertisement do not permit user feedback, the methodology determines sufficient exposure and applicable heuristic triggers in order to infer user interest in the non-interactive advertisement at 402. Although the exposure is sufficient and heuristic triggers are indicative of user interest, a further evaluation can be made as to whether the user context validates or discounts the initial finding of interest in the non-interactive advertisement at 403. With user context corroborating the interest, then an interactive advertisement corresponding to the non-interactive advertisement is accessed at 404. This can be accomplished by creating an interactive advertisement corresponding to the non-interactive advertisement. The interactive advertisement is sent to the user via an appropriate device at 405. For example, the interactive advertisement may be sent to a selected device associated with the user, and/or at a selected time, such as a time when it is likely that the user will be able to act on the interactive advertisement. Further, in an optional aspect, the effectiveness of the interactive advertisement can then be gauged at 406.

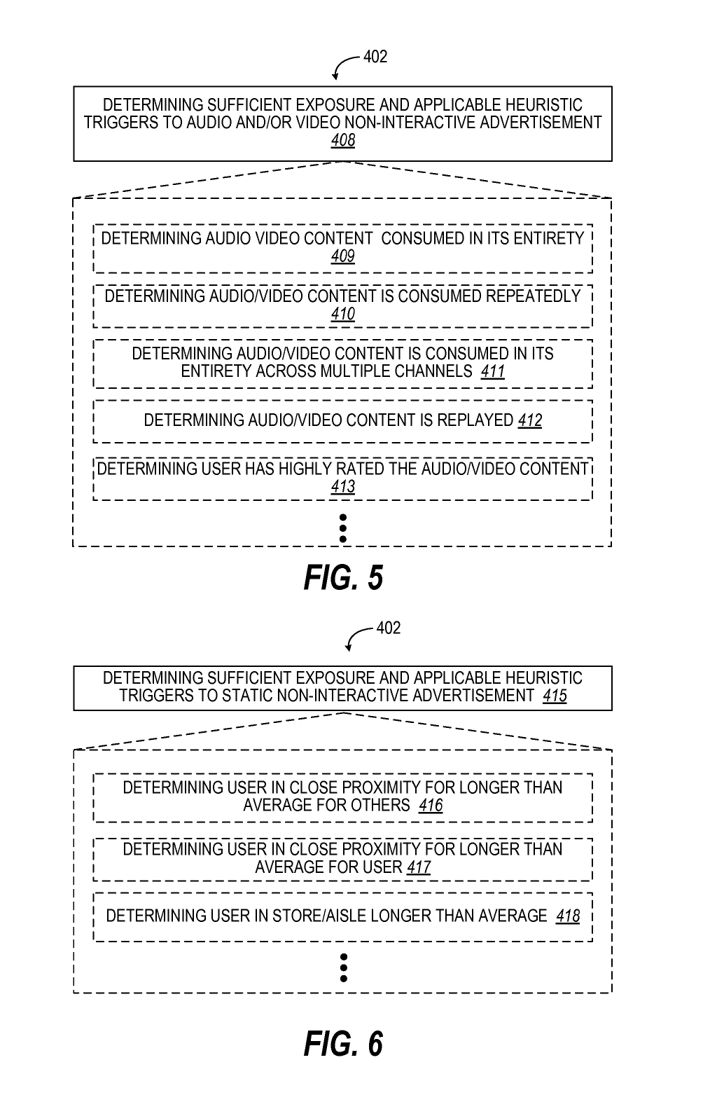

Referring to FIGS. 5 and 6, the methodology of determining sufficient exposure and applicable heuristic triggers (FIG. 4, 402) may vary, for example, depending on a type of non-interactive advertisement.

For example, in FIG. 5, one or more aspects of determining sufficient exposure and applicable heuristic triggers can be inferred with regard to user exposure to an audio and/or video type of non-interactive advertisement at 408. The heuristic trigger to convert the audio and/or video non-interactive advertisement to an interactive advertisement can be based on one or more criteria, as described below. It should be appreciated, however, that the following list is illustrative and not all inclusive.

Sufficient exposure and applicable heuristic triggers may be determined for the audio and/or video non-interactive advertisement (e.g., radio, television) by performing one or more of the following evaluations:

(a) Determining that the audio and/or video content (non-interactive advertisement) is consumed in its entirety at 409. In an aspect, for example, a given TV advertisement is watched in its entirety on a given TV channel and no TV advertisement is watched in its entirety immediately before or immediately after the given TV advertisement;

(b) Determining that the audio and/or video content has been consumed repeatedly at 410. For example in the TV advertisement scenario, the given TV advertisement is watched more than once in its entirety on a given channel across different viewing times;

(c) Determining that the audio and/or video content has been consumed in its entirety across multiple channels, for example, in a give time period at 411;

(d) Determining that the audio and/or video content was actively replayed by the user at 412. For example, the user pauses, rewinds and replays the given audio and/or video advertisement in its entirety; or

(e) Determining that the video content received a high rating by the user at 413. For example, the user rates the given TV ad, using IPTV controls, with a high score, for example, while the given TV advertisement in progress.

Alternatively or in addition, the non-interactive advertisement may be a static content, e.g., billboard advertisement or retail signage. In these aspects, exposure may be linked more to the location of the user. In one aspect, such an advertisement is publicly viewed external to any mobile device carried by a user while the user is in transit. In another aspect, such an advertisement can be a static or static over a period of time.

For example, in FIG. 6, one or more aspects of determining sufficient exposure and applicable heuristic triggers can be inferred with regard to user exposure to the static type of non-interactive advertisement at 415. The heuristic trigger to convert the static non-interactive advertisement to an interactive advertisement can be based on one or more of the following criteria: It should be appreciated, however, that the following list is illustrative and not all inclusive.

(a) Determining that the given user stood in close proximity of the billboard/store advertisement for a length of time that was greater than the average time spent by all users in the given area within a specified time period at 416;

(b) Determining that the given user stood in close proximity of the billboard/store advertisement for a length of time that was greater than the average time the given user spent anywhere else within a specified time period at 417; or

(c) Determining that the given user entered a store and stayed in the store or within a store aisle for a length of time that was greater than the average time spent by all users in the store/store aisle within a specified time period at 418;

The methodology of validating or discounting exposure time or heuristic triggers based upon one or more behavioral context parameters (FIG. 4, block 403) may include determinations to assess whether such behavioral context parameters correlate with user's interest to the non-interactive advertisement. Thus, the heuristic trigger could be conditioned by one or more of the following illustrative and not all inclusive criteria.

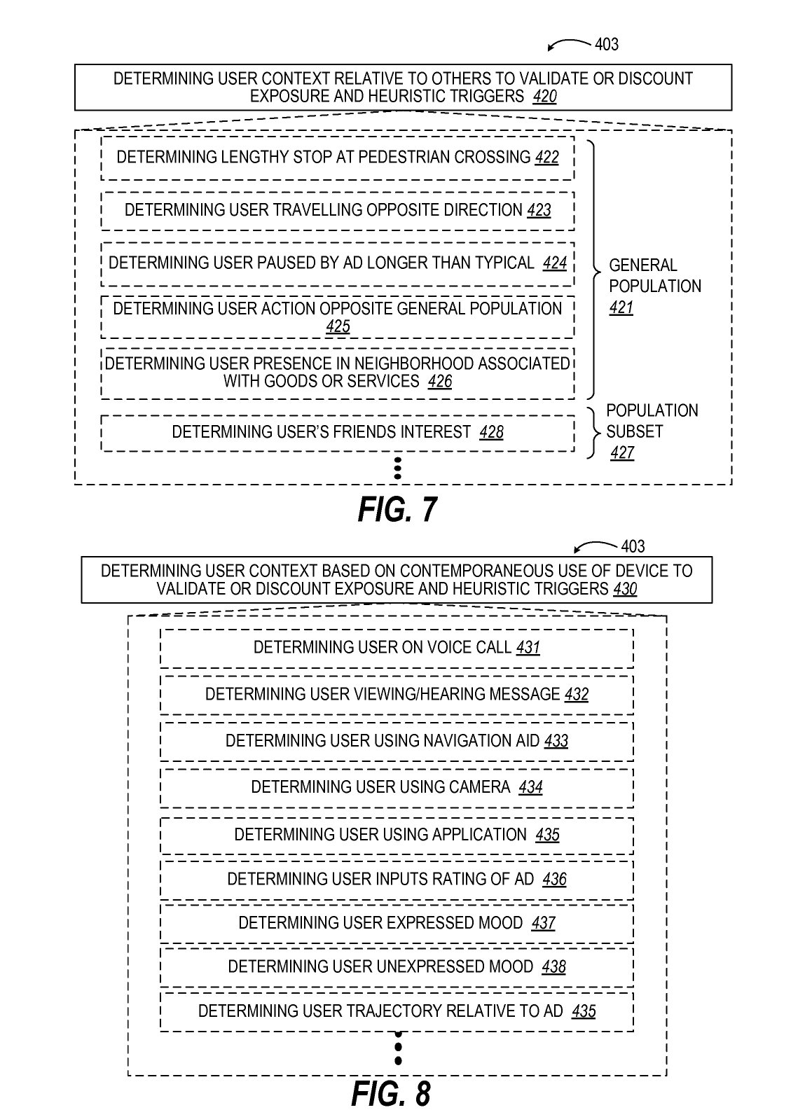

Referring to FIG. 7, in one aspect, the methodology (FIG. 4, 403) may include determining a user context relative to others to validate or discount exposure and heuristic triggers at 420. Determining a user context relative to others may include, but are not limited to, one or more of criteria relative to a general population at 421, or criteria relative to a subset of the population at 427.

Specific examples of criteria relative to a general population (block 421) may include, but are not limited to, scenarios such as:

(a) Determining if a lengthy stop occurred at a pedestrian crossing at 422. For example, although all users stop at a given location due to physical characteristics such as a traffic light, stop sign, stop light, subway entrance, bus stop, etc., a given user exceeds the average time spent by other users at that location at a given time;

(b) Determining if user was travelling in an opposite direction at 423. For example, a user is travelling in a direction that is opposite to the rest of the users in coming close to the physical advertisement can increase the likelihood of user interest;

(c) Determining if user paused by the non-interactive advertisement longer than typical for the general population at 424. For example, the user pauses at a digital product placement longer than that by the general population;

(d) Determining that a user performed an action that is opposite of the general population's action (e.g., shows disinterest or lowers exposure interest score) at 425; or

(e) Determining if the user's presence in a neighborhood is associated with particular goods or services at 426. For example, surroundings/neighborhood characteristics (e.g., travel agencies, diamond district, etc.) determine the user's interest to the associated advertisements as a population.

The criteria that may be evaluated to determine the user's behavior relative to a subset of a general population, such as a social network associated with the user at 427, may include, but are not limited to, a determination as to a user's friends' interests in relation to the non-interactive advertisement in order to infer a preference at 428. For example, the user's friends may have expressed a strong interest in a given advertisement through user ratings and/or social recommendations, and such a preference may thereby be inferred to the user.

Continuing to FIG. 8, alternatively or in addition to the aspects described above in FIG. 7, determining one or more behavioral context parameters that validate or discount the exposure and heuristic triggers (FIG. 4, 403) can be based on a user's usage or interactions with a wireless device at 430. Such determinations may include, but are not limited to, one or more of:

(a) Determining whether the user is on a voice call at 431. For example, determining the user is on a voice call while stopping by the advertisement or watching television;

(b) Determining whether the user was viewing/hearing a message at 432. For example, the user gets a message (Short Message Service (SMS), Multimedia Messaging Service (MMS), email), and hence stopped by an advertisement or paused a p TV advertisement, to read the message on the phone. For example, a determination can be made based upon user inputs to a graphical user interface (GUI) that the user was sufficiently preoccupied with the SMS, MMS, or email not to be viewing the non-interactive advertisement;

(c) Determining whether the user was using a navigation aid at 433. For example, the user is looking at a map on the phone to ensure the directions are right;

(d) Determining whether the user was using a camera at 434. For example, the user is clicking a picture of a nearby site with the wireless device;

(e) Determining whether the user is using an application at 435. For example, the user is using an application (e.g., game) on the phone;

(f) Determining whether the user has input a rating of the non-interactive advertisement at 436. For example, the user provides a one-touch thumb-up-down response/intent, or a numerical or alphabetic rating, toward a given advertisement through the wireless device;

(g) Determining whether the user has an expressed mood at 437. For example, the user's presence information based on the user's mood indicates “I am happy” as a status indicator;

(h) Determining the user's unexpressed mood at 438. For example, detectable biometric triggers/body language—heart rate increase, dilated pupils, blood pressure change, etc., in aspects where the wireless device includes wireless health monitoring components; or

(i) Determining a user trajectory relative to the non-interactive advertisement at 435. For example, the trajectory can be based on the user's velocity, knowing more about the user's exposure and line of sight, e.g. if the user is riding a bike, driving a car, walking, etc. at 435.

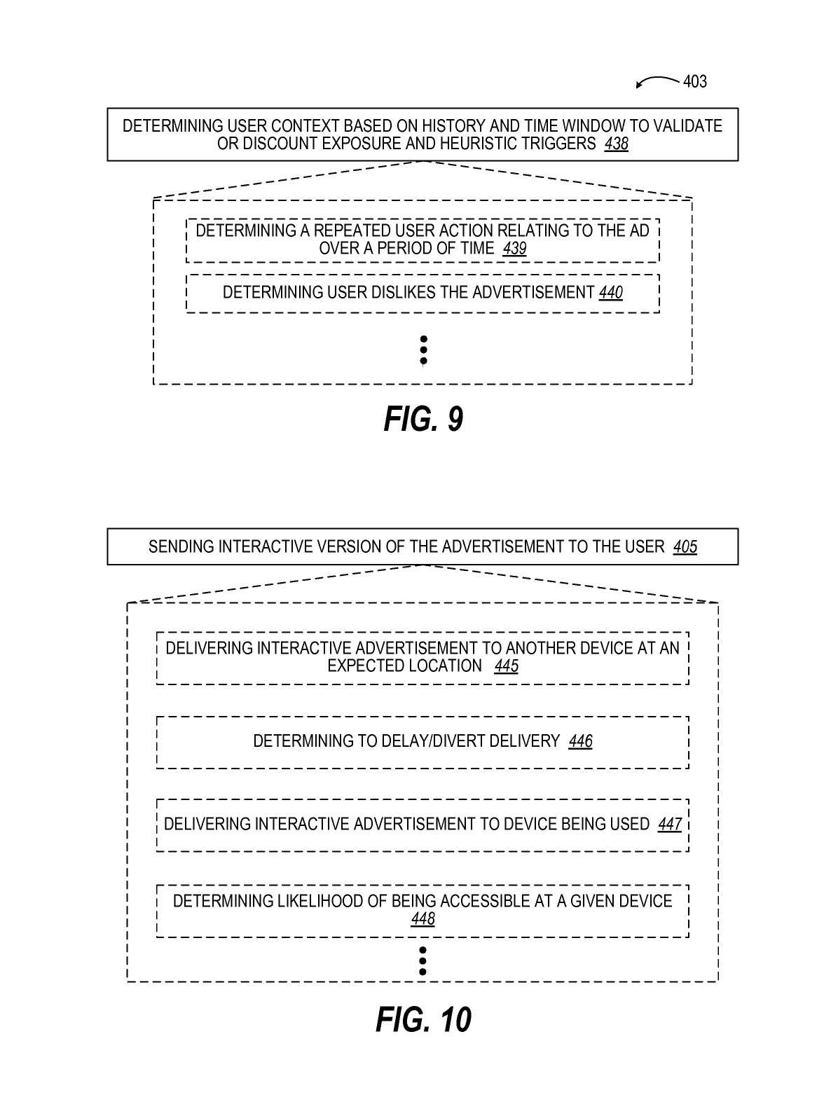

Continuing to FIG. 9, alternatively or in addition to the aspects described above in FIGS. 7 and 8, determining one or more behavioral context parameters that validate or discount the exposure and heuristic triggers (FIG. 4, 403) can include determinations based on history and/or a time window at 438. Such determinations may include, but are not limited to, one or more of:

(a) Determining a repeated user action relating to the non-interactive advertisement over a period of time at 439. For example, over a given time period, the user repeats the same action pertaining to the advertisement, such as stopping at the same location (e.g. to hear or view a static non-interactive advertisement), or pausing and replaying the advertisement on TV (e.g. to hear/view an audio/video non-interactive advertisement); or

(b) Determining that the user dislikes an advertisement at 440. For example, the user Fast Forwards through the advertisement on TV repeatedly or avoids using a gift card/coupon from a store, indicating a lack of interest/compatibility with the advertisement;

Referring to FIG. 10, the methodology of sending an interactive advertisement corresponding to the non-interactive advertisement (FIG. 4, 405) may vary, for example, depending on a device or time at which the user may be expected to be able to interact with the interactive advertisement. Such sending of the interactive advertisement may include, but is not limited to, one or more of:

(a) Delivering the interactive advertisement to another device at an expected location at 445. For example, based on the user's velocity and direction, the user is on his way home, so instead of delivering the advertisement on the user's phone as a text message, the advertisement is delivered to the user's home computer as an email;

(b) Determining to delay or divert delivery at 446. For example, if the user is in transit, such as on a flight, a text message including access to the interactive advertisement is queued to be sent to the user when the user lands. If the flight has a wireless connection, such as WiFi, the user may be provided an email with a link to the interactive advertisement;

(c) Delivering interactive content to the wireless device being used at 447. For example, the user is using a media-shifting application like SLINGBOX of SKIFTA™ by QUALCOMM Incorporated of San Diego, Calif. to watch TV on his computer or mobile phone. The advertisement that the user is interested in is delivered to the device on which the show is being watched; or

(d) Determining a likelihood of being accessible at a given device at 448. For example, a probability of being in front of a delivery device (home computer, mobile device, work computer) is modeled based on historical information relating to the user's mobility.

With benefit of the foregoing, the methodologies are capable of obtaining interactive advertisements when appropriately determined that passively exhibited interest has been demonstrated in a non-interactive advertisement. By some collaboration between, or sole efforts of, a mobile device or remote server, exposure is determined to a non-interactive advertisement. One or more behavioral context parameters are determined to correspond to the exposure to the non-interactive advertisement. The one or more behavioral context parameters include an exposure duration of the exposure to the non-interactive advertisement. It is determined whether a correlation exists between the non-interactive advertisement and the one or more behavioral context parameters. The correlation includes, at least in part, determining that the exposure duration achieves an exposure threshold. If the correlation exists, a trigger is generated to obtain an interactive advertisement corresponding to the non-interactive advertisement.

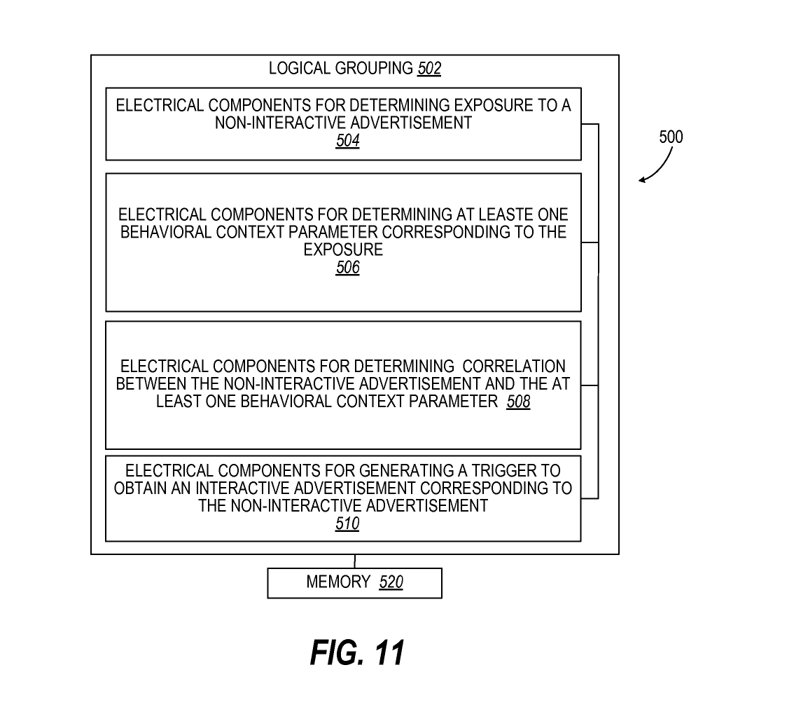

With reference to FIG. 11, illustrated is a system 500 for delivering advertisement to a user, according to one aspect. For example, system 500 can reside at least partially within a mobile device. It is to be appreciated that system 500 is represented as including functional blocks, which can be functional blocks that represent functions implemented by a computing platform, processor, software, or combination thereof (e.g., firmware). System 500 includes a logical grouping 502 of electrical components that can act in conjunction. For instance, logical grouping 502 can include an electrical component for determining exposure to a non-interactive advertisement 504. Moreover, logical grouping 502 can include an electrical component for determining one or more behavioral context parameters corresponding to the exposure to the non-interactive advertisement 506. The one or more behavioral context parameters include exposure duration of the exposure to the non-interactive advertisement. For another instance, logical grouping 502 can include an electrical component for determining whether a correlation exists between the non-interactive advertisement and the one or more behavioral context parameters 508. The correlation includes, at least in part, determining that the exposure duration achieves an exposure threshold. For an additional instance, logical grouping 502 can include an electrical component for generating a trigger to obtain an interactive advertisement corresponding to the non-interactive advertisement if the correlation exists 510. Additionally, system 500 can include a memory 520 that retains instructions for executing functions associated with electrical components 504, 506, 508, and 510. While shown as being external to memory 520, it is to be understood that one or more of electrical components 504, 506, 508 and 510 can exist within memory 520.

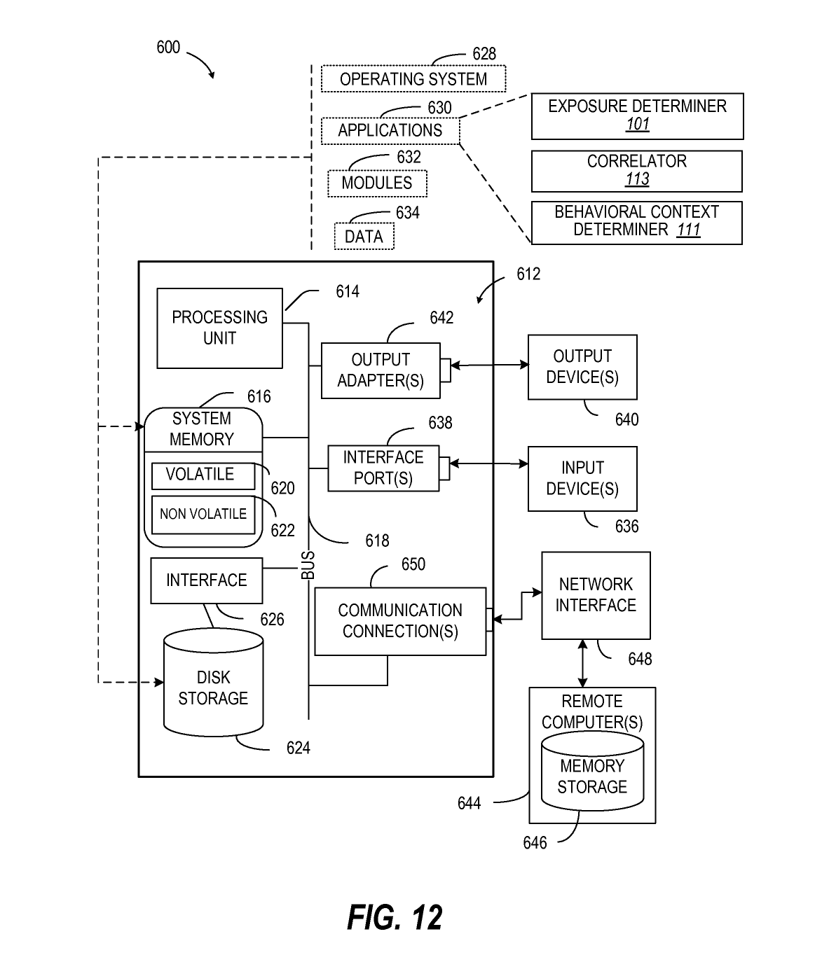

With reference to FIG. 12, an exemplary computing environment 600 for implementing various aspects of the claimed subject matter includes a computer 612, such as but not limited to a network server. The computer 612 includes a processing unit 614, a system memory 616, and a system bus 618. The system bus 618 couples system components including, but not limited to, the system memory 616 to the processing unit 614. The processing unit 614 can be any of various available processors. Dual microprocessors and other multiprocessor architectures also can be employed as the processing unit 614.

The system bus 618 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 694), and Small Computer Systems Interface (SCSI).

The system memory 616 includes volatile memory 620 and nonvolatile memory 622. The basic input/output system (BIOS), containing the basic routines to transfer information between elements within the computer 612, such as during start-up, is stored in nonvolatile memory 622. By way of illustration, and not limitation, nonvolatile memory 622 can include read only memory (ROM), programmable ROM (PROM), electrically programmable ROM (EPROM), electrically erasable programmable ROM (EEPROM), or flash memory. Volatile memory 620 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 612 also includes removable/non-removable, volatile/non-volatile computer storage media. FIG. 12 illustrates, for example, disk storage 624. Disk storage 624 includes, but is not limited to, devices like a magnetic disk drive, floppy disk drive, tape drive, Jaz drive, Zip drive, LS-100 drive, flash memory card, or memory stick. In addition, disk storage 624 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 624 to the system bus 618, a removable or non-removable interface is typically used such as interface 626.

It is to be appreciated that the software described in FIG. 12 acts as an intermediary between users and the basic computer resources described in the suitable computing environment 600. Such software includes an operating system 628. Operating system 628, which can be stored on disk storage 624, acts to control and allocate resources of the computer 612. System applications 630 take advantage of the management of resources by operating system 628 through program modules 632 and program data 634 stored either in system memory 616 or on disk storage 624. It is to be appreciated that the claimed subject matter can be implemented with various operating systems or combinations of operating systems.

In an aspect, for example, system applications 630 may include all or some portion of the exposure determiner 101, the correlator 113, and the behavioral context determiner 111, as previously described in FIG. 1, for carrying out the functionality relating to determining interest in a non-interactive advertisement 108 and delivering a corresponding interactive advertisement 120, as described herein. It should be understood, however, that the above-noted components may instead be part of the hardware of computing environment 600, such as but not limited to being embodied in the processing unit 614.

As shown in FIG. 12, a user enters commands or information into the computer 612 through input device(s) 636. Input device(s) 636 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 614 through the system bus 618 via interface port(s) 638. Interface port(s) 638 include, for example, a serial port, a parallel port, a game port, and a universal serial bus (USB). Output device(s) 640 use some of the same type of ports as input device(s) 636. Thus, for example, a USB port may be used to provide input to computer 612 and to output information from computer 612 to an output device 640. Output adapter 642 is provided to illustrate that there are some output devices 640 like monitors, speakers, and printers, among other output devices 640, which require special adapters. The output adapters 642 include, by way of illustration and not limitation, video and sound cards that provide a means of connection between the output device 640 and the system bus 618. It should be noted that other devices and/or systems of devices provide both input and output capabilities such as remote computer(s) 644.

Computer 612 can operate in a networked environment using logical connections to one or more remote computers, such as remote computer(s) 644. The remote computer(s) 644 can be a personal computer, a server, a router, a network PC, a workstation, a microprocessor based appliance, a peer device or other common network node and the like, and typically includes many or all of the elements described relative to computer 612. For purposes of brevity, only a memory storage device 646 is illustrated with remote computer(s) 644. Remote computer(s) 644 is logically connected to computer 612 through a network interface 648 and then physically connected via communication connection 650. Network interface 648 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 650 refers to the hardware/software employed to connect the network interface 648 to the system bus 618. While communication connection 650 is shown for illustrative clarity inside computer 612, it can also be external to computer 612. The hardware/software necessary for connection to the network interface 648 includes, for exemplary purposes only, internal and external technologies such as, modems including regular telephone grade modems, cable modems and DSL modems, ISDN adapters, and Ethernet cards.

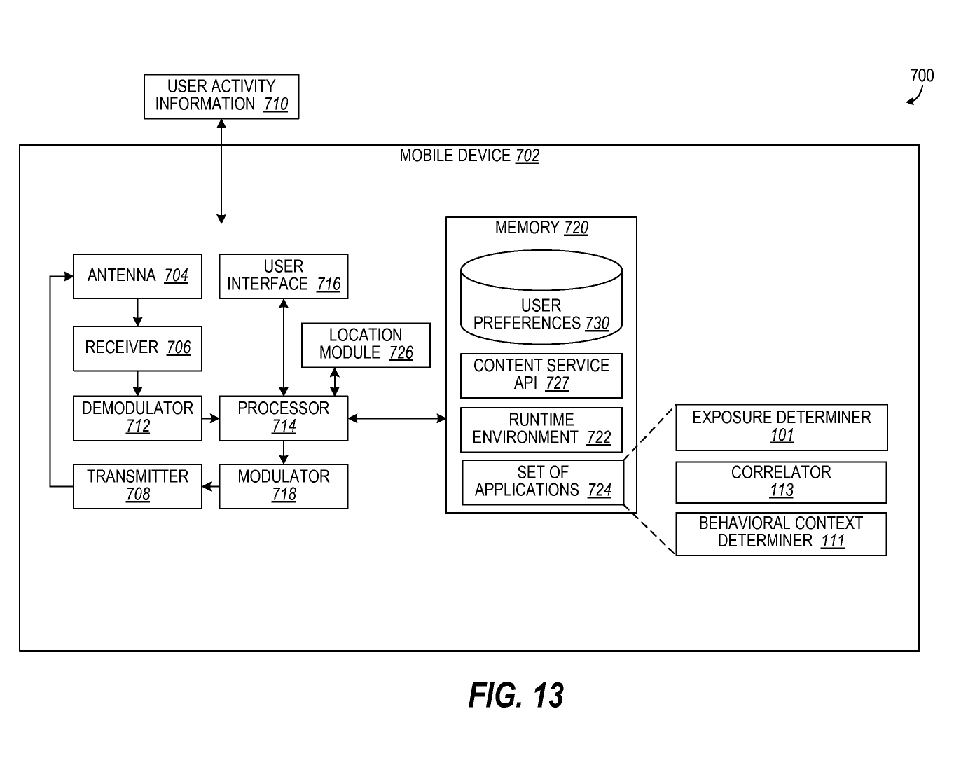

FIG. 13 illustrates an exemplary communication system 700 having a configuration of hardware, software, and other resources of a mobile device 702, consistent with one or more implementations of the present teachings. Mobile device 702 can include at least one antenna 704 (e.g., a transmission receiver or group of such receivers comprising an input interface, etc.) that receives a signal (e.g., pertaining to a mobile call initiation or other handshake, a handshake response, a mobile application data transfer, a data event, data event response, handshake termination, and so on) and a receiver 706, which performs actions (e.g., filters, amplifies, down-converts, etc.) on the received signal. Antenna 704 can be further coupled to a transmitter 708 to transmit signals. Antenna 704 can for example transmit or receive a response to a handshake request, data event request, or the like. Transmitted or received signals can be or include a set of user activity information 710, and other data, as described herein, such as information gleaned by the mobile device 702 or by the communication system 700 remote to the mobile device 702, respectively. Antenna 704 and receiver 706 can also be coupled with a demodulator 712 that can demodulate received signals and provide the demodulated information to a processor 714 for processing. Mobile device 702 can additionally include memory 720 that is coupled to processor 714 and that can store data to be transmitted, received, and the like.

Processor 714 can analyze user activity information 710 received by antenna 704 or a user interface 716 of the mobile device 702 and/or generate user activity information 710 or other data for transmission by a transmitter 708 via a modulator 718. Additionally, processor 714 can control and/or access one or more resources or components (e.g., 722, 724, etc.) of the mobile device 702. Processor 714 can execute a runtime environment 722, such as Brew® runtime environment available from QUALCOMM Incorporated, as well as one or more set of applications 724 or other software, modules, applications, logic, code, or the like. In one or more aspects, set of applications 724 can include client or user preferences 730 and/or other applications or resources. Also, in an aspect, for example, set of applications 724 can include all or some portion of the exposure determiner 101, the correlator 113, and the behavioral context determiner 111, as previously described in FIG. 1, for carrying out the functionality relating to determining interest in a non-interactive advertisement 108 and delivering a corresponding interactive advertisement 120, as described herein. It should be understood, however, that the above-noted components may instead be part of the hardware portion of mobile device 702, such as but not limited to being embodied in processor 714. Processor 714 can in one or more implementations communicate with a location module 726, such as a Global Positioning System (GPS) module or chip, to receive and process location-related information, including location fixes for the user. Processor 714 can further communicate with a content service application programming interface (API) 728 to invoke catalog processing functions to execute function calls to extract user activity information 710 and perform other actions, according to the present teachings. Processor 714 can likewise couple with user interface 716, such as a graphical user interface or other graphical display, to display non-interactive advertisement 108 (FIG. 1) and/or interactive advertisement 120 (FIG. 1), graphics, video, call-related data, user activity feeds as described herein, and other information.

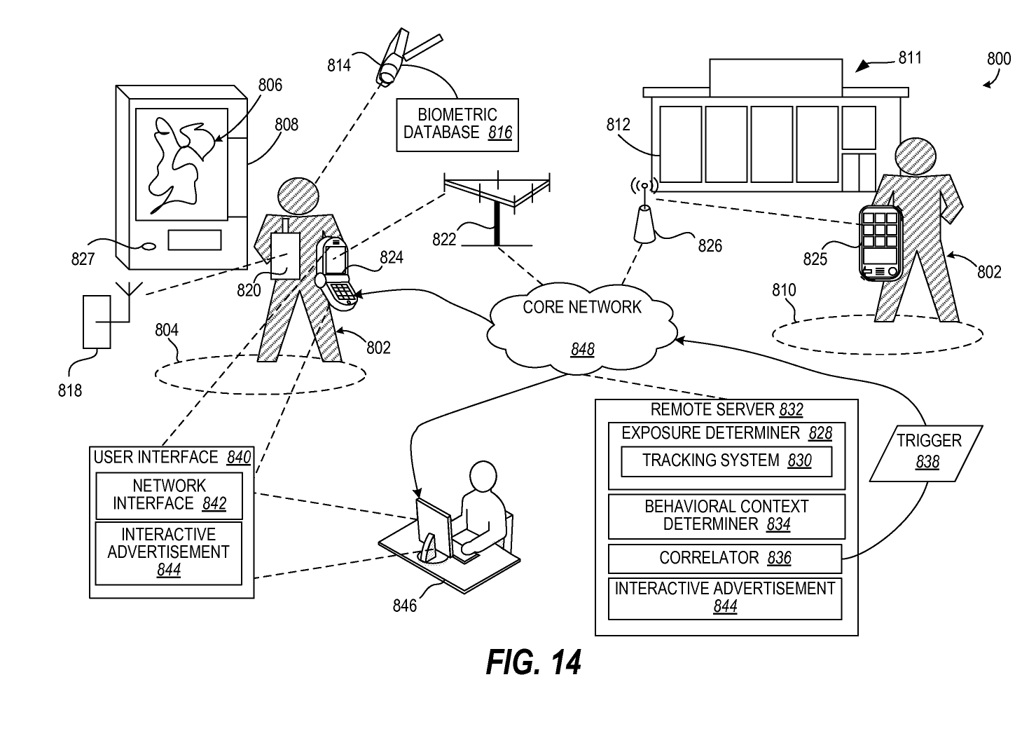

In FIG. 14, a system 800 is depicted for using distributed sensors and processes including fixed infrastructure for delivering interactive advertisements deemed appropriate based upon exposure to non-interactive advertisements, according to one aspect. System 800 may also include a use case that involves distributing processing among different components in the system.

Consider, in one aspect, a user 802 who is in a first position 804 near to a first non-interactive advertisement 806, depicted as on a vending machine 808. Similarly, in another aspect, the user 802 can be detected as being at a second position 810 exposed to a second non-interactive advertisement 811, depicted as at a retail store window 812. These two aspects are discussed together below, however, it should be understood that each aspect may occur separately.

A surveillance camera system 814 with face recognition capability recognizes the user 802, such as by accessing an employee biometric database 816. Alternatively, a Radio Frequency Identifier (RFID) antenna 818 detects an employee identifier (ID) badge 820 carried by the user 802. Alternatively or in addition, a mobile carrier 822 detects a GPS value transmitted by a WWAN mobile device 824 carried by the user 802. The mobile carrier 822 can also detect a coarse location coordinate for the mobile device 824 that is correlated to being in proximity to the vending machine 808 or store window 812 based upon a sensor 827. For example, the vending machine 808 detects that someone is standing in front of the device and the mobile carrier 822 can detect only one person that is in that area. The duration of exposure can be detected based upon a period of time in which a WLAN-capable device 825 carried by the user 802 is within the coverage area of an access point 826.

An exposure determiner 828 detects exposure to the non-interactive advertisement 806 and/or 811. For instance, a subroutine of an employee attendance tracking system 830 in a remote server 832 determines exposure to the non-interactive advertisement 806 and/or 811 by associating the user 802 to the location (position) 804 and/or 810 and to the non-interactive advertisement 806 and/or 811, respectively. The exposure determiner 828 may be the same as or similar to exposure determiner 101 (FIG. 1). Alternatively, this association can be performed solely by the respective device 824 and/or 825 carried by the user 802. As a further alternative, the exposure determiner 828 can be distributed between the respective device 824 or 825 and the remote server 832.

A behavioral context determiner 834 in the remote server 832 determines one or more behavioral context parameters, including exposure duration, corresponding to the exposure to the non-interactive advertisements 806 and/or 811. The behavioral context determiner 834 may be the same as or similar to behavioral context determiner 111 (FIG. 1). Alternatively, this context can be determined solely by the respective device 824 and/or 825 carried by the user 802. As a further alternative, the exposure determiner 828 can be distributed between the respective device 824 or 825 and the remote server 832.

A correlator 836 in the remote server 832 determines whether a correlation exists between the non-interactive advertisement 806 and/or 811 and the one or more behavioral context parameters. The correlation includes, at least in part, determining that the exposure duration achieves an exposure threshold. The correlator 836 may be the same as or similar to correlator 113 (FIG. 1). The correlator 836 generates a trigger 838. Alternatively, the correlation can be determined solely by the respective device 824 and/or 825 carried by the user 802. As a further alternative, the exposure determiner 828 can be distributed between the respective device 824 or 825 and the remote server 832.

A user interface 840 has a network interface 842 that obtains an interactive advertisement 844 corresponding to the non-interactive advertisement in response to the correlation existing as prompted by the trigger 838. For example, a workstation 846 of the user can receive the interactive advertisement 844 pushed over a core network 848. Alternatively, the device 824 carried by the user 802 can pull the interactive advertisement 844 from the mobile carrier 822.

Variations, modification, and other implementations of what is described herein will occur to those of ordinary skill in the art without departing from the spirit and scope of the disclosure as claimed. Accordingly, the disclosure is to be defined not by the preceding illustrative description but instead by the spirit and scope of the following claims.

What is claimed is:

1. A method of delivering advertisements, comprising:
determining exposure to a non-interactive advertisement;
determining at least one behavioral context parameter corresponding to the exposure to the non-interactive advertisement, wherein the at least one behavioral context parameter includes an exposure duration of the exposure to the non-interactive advertisement;
determining whether a correlation exists between the non-interactive advertisement and the at least one behavioral context parameter, wherein the correlation includes, at least in part, determining that the exposure duration achieves an exposure threshold; and
generating a trigger to obtain an interactive advertisement corresponding to the non-interactive advertisement if the correlation exists.

2. The method of claim 1, further comprising:
obtaining a sample population exposure time corresponding to the non-interactive advertisement, wherein the sample population exposure time is a function of a plurality of user exposure times corresponding to the non-interactive advertisement collected from a plurality of users; and
wherein determining that the exposure duration achieves the exposure threshold further comprises determining that the exposure duration is greater than the sample population exposure time.

3. The method of claim 2, wherein the sample population exposure time further comprises an average exposure time spent by the plurality of users in a vicinity of the non-interactive advertisement within a time period.

4. The method of claim 3, wherein the plurality of users comprise either all users in the vicinity of the non-interactive advertisement within the time period, or a subset of all the users in the vicinity of the non-interactive advertisement within the time period.

5. The method of claim 1, further comprising:
determining an average time a user spent at other locations within a time period,
wherein determining that the exposure duration achieves the exposure threshold further comprises determining that the exposure duration is greater than the average time the user spent at other locations within the time period.

6. The method of claim 1, further comprising:
obtaining a minimum exposure time corresponding to the non-interactive advertisement,
wherein determining that the exposure duration achieves the exposure threshold further comprises determining that the exposure duration is greater than the minimum exposure time.

7. The method of claim 1, further comprising:
obtaining a history information of user movements over a time period,
wherein determining that the exposure duration achieves the exposure threshold further comprises determining, in combination with the exposure duration and based on the history information, that a pattern of historical exposure durations corresponds to the non-interactive advertisement.

8. The method of claim 1, further comprising receiving the interactive advertisement at a location determined based on a determined behavioral context parameter.

9. The method of claim 8, wherein receiving the interactive advertisement further comprises at least one of:
receiving on a wireless device when location information of the wireless device corresponds to a vicinity of the non-interactive advertisement during the exposure duration; or
receiving at an e-mail account or on a wired communication device when the determined behavioral context parameter identifies a subject matter of the interactive advertisement as corresponding to historical purchases over the Internet using the wired communication device; or
receiving at an e-mail account or on a wired communication device when the determined behavioral context parameter identifies a user velocity greater than a velocity threshold; or
receiving via a text message; or
receiving via an Internet Protocol television pop-up menu.

10. The method of claim 1, wherein determining at least one behavioral context parameter corresponding to the exposure to the non-interactive advertisement further comprises determining a user interaction with a wireless device over a time period, and wherein determining that the exposure duration achieves the exposure threshold further comprises determining that the exposure duration does not occur during the time period corresponding to the user interaction with the wireless device.

11. The method of claim 1, further comprising:
obtaining an advertisement duration of the non-interactive advertisement; and
obtaining other advertisement exposure information for other advertisements adjacent in time to the non-interactive advertisement,
wherein determining that the exposure duration achieves the exposure threshold further comprises determining that the exposure duration is greater than a minimum portion of the advertisement duration, and determining that the other advertisement exposure information indicates a lack of other advertisement exposure.

12. The method of claim 1, further comprising:
obtaining user behavior advertisement history corresponding to the non-interactive advertisement,
wherein determining that the exposure duration achieves the exposure threshold further comprises determining that the exposure duration combined with the user behavior advertisement history indicates interest in the non-interactive advertisement.

13. The method of claim 12, wherein the user behavior advertisement history comprises at least one of:
information indicating that the non-interactive advertisement is viewed more than once for greater than a minimum viewing time over a time period; or
information indicating that the non-interactive advertisement is viewed more than once across multiple channels over a time period; or
information indicating that the non-interactive advertisement is paused, rewound or replayed; or
information indicating that a user rating greater than a minimum rating threshold is received during the exposure duration.

14. The method of claim 1, further comprising detecting an input for the at least one behavioral context parameter at a mobile device.

15. The method of claim 1, further comprising detecting an input for the at least one behavioral context parameter at a network remote to the non-interactive advertisement.

16. The method of claim 15, further comprising detecting another input for the at least one behavioral context parameter at a mobile device.

17. At least one processor for delivering advertisements, comprising:
a first module for determining exposure to a non-interactive advertisement;
a second module for determining at least one behavioral context parameter corresponding to the exposure to the non-interactive advertisement, wherein the at least one behavioral context parameter includes an exposure duration of the exposure to the non-interactive advertisement;
a third module for determining whether a correlation exists between the non-interactive advertisement and the at least one behavioral context parameter, wherein the correlation includes, at least in part, determining that the exposure duration achieves an exposure threshold; and
a fourth module for generating a trigger to obtain an interactive advertisement corresponding to the non-interactive advertisement if the correlation exists.

18. A computer program product for delivering advertisements, comprising:
a computer-readable storage medium comprising,
at least one instruction for causing a computer to determine exposure to a non-interactive advertisement;
at least one instruction for causing the computer to determine at least one behavioral context parameter corresponding to the exposure to the non-interactive advertisement, wherein the at least one behavioral context parameter includes an exposure duration of the exposure to the non-interactive advertisement;
at least one instruction for causing the computer to determine whether a correlation exists between the non-interactive advertisement and the at least one behavioral context parameter, wherein the correlation includes, at least in part, determining that the exposure duration achieves an exposure threshold; and
at least one instruction for causing the computer to generate a trigger to obtain an interactive advertisement corresponding to the non-interactive advertisement if the correlation exists.

19. An apparatus for delivering advertisements, comprising:
means for determining exposure to a non-interactive advertisement;
means for determining at least one behavioral context parameter corresponding to the exposure to the non-interactive advertisement, wherein the at least one behavioral context parameter includes an exposure duration of the exposure to the non-interactive advertisement;
means for determining whether a correlation exists between the non-interactive advertisement and the at least one behavioral context parameter, wherein the correlation includes, at least in part, determining that the exposure duration achieves an exposure threshold; and
means for generating a trigger to obtain an interactive advertisement corresponding to the non-interactive advertisement if the correlation exists.

20. An apparatus for delivering advertisements, comprising:
an exposure determiner for determining exposure to a non-interactive advertisement;
a behavioral context determiner for determining at least one behavioral context parameter corresponding to the exposure to the non-interactive advertisement, wherein the at least one behavioral context parameter includes an exposure duration of the exposure to the non-interactive advertisement;
a correlator for determining whether a correlation exists between the non-interactive advertisement and the at least one behavioral context parameter, wherein the correlation includes, at least in part, determining that the exposure duration achieves an exposure threshold wherein the correlator is further configured to generate a trigger; and
a network interface for obtaining an interactive advertisement corresponding to the non-interactive advertisement if the correlation exists based upon the trigger.

21. The apparatus of claim 20, wherein the network interface is further for obtaining a sample population exposure time corresponding to the non-interactive advertisement, wherein the sample population exposure time is a function of a plurality of user exposure times corresponding to the non-interactive advertisement collected from a plurality of users,
wherein determining that the exposure duration achieves the exposure threshold further comprises determining that the exposure duration is greater than the sample population exposure time.

22. The apparatus of claim 21, wherein the sample population exposure time further comprises an average exposure time spent by the plurality of users in a vicinity of the non-interactive advertisement within a time period.

23. The apparatus of claim 22, wherein the plurality of users comprise either all users in the vicinity of the non-interactive advertisement within the time period, or a subset of all the users in the vicinity of the non-interactive advertisement within the time period

24. The apparatus of claim 20, wherein the behavioral context determiner is further for determining an average time a user spent at other locations within a time period,
wherein determining that the exposure duration achieves the exposure threshold further comprises determining that the exposure duration is greater than the average time the user spent at other locations within the time period.

25. The apparatus of claim 20, wherein the behavioral context determiner is further for obtaining a minimum exposure time corresponding to the non-interactive advertisement,
wherein determining that the exposure duration achieves the exposure threshold further comprises determining that the exposure duration is greater than the minimum exposure time.

26. The apparatus of claim 20, wherein the behavioral context determiner is further for obtaining a history information of user movements over a time period,
wherein determining that the exposure duration achieves the exposure threshold further comprises determining, in combination with the exposure duration and based on the history information, that a pattern of historical exposure durations corresponds to the non-interactive advertisement.

27. The apparatus of claim 20, wherein the network interface is further for receiving the interactive advertisement at a location based on a determined behavioral context parameter.

28. The apparatus of claim 27, wherein the network interface is further for receiving the interactive advertisement by at least one action of:
receiving on a wireless device when location information of the wireless device corresponds to a vicinity of the non-interactive advertisement during the exposure duration; or
receiving at an e-mail account or on a wired communication device when the determined behavioral context parameter identifies a subject matter of the interactive advertisement as corresponding to historical purchases over the Internet using the wired communication device; or
receiving at an e-mail account or on a wired communication device when the determined behavioral context parameter identifies a user velocity greater than a velocity threshold; or
receiving via a text message; or
receiving via an Internet Protocol television pop-up menu.

29. The apparatus of claim 20, wherein the behavioral context determiner is further for determining the at least one behavioral context parameter corresponding to the exposure to the non-interactive advertisement by determining a user interaction with a wireless device over a time period, and wherein determining that the exposure duration achieves the exposure threshold further comprises determining that the exposure duration does not occur during the time period corresponding to the user interaction with the wireless device.

30. The apparatus of claim 20, wherein the behavioral context determiner is further for:
obtaining an advertisement duration of the non-interactive advertisement; and
obtaining other advertisement exposure information for other advertisements adjacent in time to the non-interactive advertisement,
wherein determining that the exposure duration achieves the exposure threshold further comprises determining that the exposure duration is greater than a minimum portion of the advertisement duration, and determining that the other advertisement exposure information indicates a lack of other advertisement exposure.

31. The apparatus of claim 20, wherein the behavioral context determiner is further for:
obtaining user behavior advertisement history corresponding to the non-interactive advertisement,
wherein determining that the exposure duration achieves the exposure threshold further comprises determining that the exposure duration combined with the user behavior advertisement history indicates interest in the non-interactive advertisement.

32. The apparatus of claim 31, wherein the user behavior advertisement history comprises at least one of:
information indicating that the non-interactive advertisement is viewed more than once for greater than a minimum viewing time over a time period; or
information indicating that the non-interactive advertisement is viewed more than once across multiple channels over a time period; or
information indicating that the non-interactive advertisement is paused, rewound or replayed; or
information indicating that a user rating greater than a minimum rating threshold is received during the exposure duration.

33. The apparatus of claim 20, wherein the network interface is further for detecting an input for the at least one behavioral context parameter at a mobile device.

34. The apparatus of claim 20, wherein the network interface is further for detecting an input for the at least one behavioral context parameter at a network remote to the non-interactive advertisement.

35. The apparatus of claim 34, wherein the network interface is further for detecting another input for the at least one behavioral context parameter at a mobile device.

36. The apparatus of claim 20, wherein the exposure determiner, the behavioral context determiner and the correlator are distributed between a mobile device and a remote network that communicate via an air-interface.
